(19) United States
(12) Patent Application Publication
(10) Pub. No.: US 2006/0089093 A1
(43) Pub. Date: Apr. 27, 2006

(54) Polyurethane urea polishing pad

(76) Inventors: Robert G. Swisher, Pittsburgh, PA (US); Alan E. Wang, Gibsonia, PA (US); William C. Allison, Murrysville, PA (US)

Correspondence Address: PPG Industries, Inc.;Law Department - Intellectual Property, One PPG Place, Pittsburgh, PA, 15272, US

(21) Appl. No.: 10/974,529

(22) Filed: Oct. 27, 2004

(51) Int. Cl. B29C 44/00; B24D 11/00

(52) U.S. Cl. 451/526; 264/415

(57) ABSTRACT

The present invention relates to an article for altering a surface of a workpiece, or a polishing pad. In particular, the polishing pad includes a polyurethane urea material wherein at least a portion of the polyurethane urea material contains cells which are at least partially filled with gas. The polyurethane urea material can be prepared by combining polyisocyanate and/or polyurethane prepolymer, hydroxyl-containing material, amine-containing material and blowing agent. The polishing pad according to the present invention is useful for polishing articles, and is especially useful for chemical mechanical polishing or planarization of microelectronic and optical electronic devices such as but not limited to semiconductor wafers.

The present invention relates to an article for altering a surface of a workpiece. In particular, the present invention is directed to a polishing pad. More particularly, the polishing pad can include a polyurethane urea material wherein cells at least partially filled with gas are substantially uniformly distributed throughout the material and/or pad. The polyurethane urea material can be prepared by combining polyisocyanate and/or polyurethane prepolymer, hydroxyl-containing material, amine-containing material and blowing agent. The polishing pad according to the present invention is useful for polishing articles, and is especially useful for chemical mechanical polishing or planarization of microelectronic and optical electronic devices such as but not limited to semiconductor wafers.

The polishing or planarization of a rough surface of an article such as a microelectronic device, to a substantially smooth surface generally involves rubbing the rough surface with the work surface of a polishing pad using a controlled and repetitive motion. A polishing fluid can be interposed between the rough surface of the article that is to be polished and the work surface of the polishing pad.

The fabrication of a microelectronic device can comprise the formation of a plurality of integrated circuits on a semiconductor substrate. The composition of the substrate can include silicon or gallium arsenide. The integrated circuits generally can be formed by a series of process steps in which patterned layers of materials, such as conductive, insulating and semi-conducting materials, are formed on the substrate. In order to maximize the density of integrated circuits per wafer, it is desirable to have a planar polished substrate at various stages throughout the production process. As such, production of a microelectronic device typically involves at least one polishing step and can often involve a plurality of polishing steps, which can result in the use of more than one polishing pad.

The polishing step can include rotating the polishing pad and the semiconductor substrate against each other in the presence of a polishing fluid. The polishing fluid can be mildly alkaline and can optionally contain an abrasive particulate material such as but not limited to particulate cerium oxide, particulate alumina, or particulate silica. The polishing fluid can facilitate the removal and transport of abraded material off and away from the rough surface of the article.

Polishing pad characteristics such as pore volume and pore size can vary from pad-to-pad and throughout the operating lifetime of a particular pad. Variations in the polishing characteristics of the pads can result in inadequately polished and planarized substrates which can be unsuitable for fabricating semiconductor wafers. Thus, it is desirable to develop a polishing pad that exhibits reduced pad-to-pad variation in polishing and planarization characteristics. It is further desirable to develop a polishing pad that exhibits reduced variations in polishing and planarization characteristics throughout the operating lifetime of the pad.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The present invention includes a pad adapted to polish a microelectronic substrate. The pad comprises polyurethane urea material containing cells that are at least partially filled with gas. At least a portion of the at least partially gas-filled cells is formed by an in-situ reaction. In a non-limiting embodiment, the cells can be substantially uniformly distributed throughout the material and/or pad.

In alternate non-limiting embodiments, the polyurethane urea of the present invention can be prepared by combining a polyisocyanate with hydroxyl-containing material, amine-containing material and blowing agent; or by reacting a two-component composition comprising combining polyisocyanate and hydroxyl-containing material to form a polyurethane prepolymer, and then reacting the prepolymer with amine-containing material and blowing agent; or by combining polyisocyanate and polyurethane prepolymer, optional hydroxyl-containing material, amine-containing material and blowing agent.

In alternate non-limiting embodiments, the amount of polyisocyanate, hydroxyl-containing material and amine-containing material can be selected such that the equivalent ratio of (NCO+NCS):(NH+OH) can be greater than 0.95, or at least 1.0, or at least 1.05, or less than 1.3, or less than 1.2, or less than 1.1.

Polyisocyanates useful in the preparation of the polyurethane urea of the present invention are numerous and widely varied. Suitable polyisocyanates can include but are not limited to polymeric and C₂-C₂₀ linear, branched, cyclic and aromatic polyisocyanates. Non-limiting examples can include polyisocyanates having backbone linkages chosen from urethane linkages (—NH—C(O)—O—).

The molecular weight of the polyisocyanate can vary widely. In alternate non-limiting embodiments, the number average molecular weight (Mn) can be at least 100 grams/mole, or at least 150 grams/mole, or less than 15,000 grams/mole, or less than 5000 grams/mole. The number average molecular weight can be determined using known methods. The number average molecular weight values recited herein and the claims were determined by gel permeation chromatography (GPC) using polystyrene standards.

Non-limiting examples of suitable polyisocyanates can include but are not limited to polyisocyanates having at least two isocyanate groups.

Non-limiting examples of polyisocyanates can include but are not limited to aliphatic polyisocyanates, cycloaliphatic polyisocyanates wherein one or more of the isocyanato groups are attached directly to the cycloaliphatic ring, cycloaliphatic polyisocyanates wherein one or more of the isocyanato groups are not attached directly to the cycloaliphatic ring, aromatic polyisocyanates wherein one or more of the isocyanato groups are attached directly to the aromatic ring, and aromatic polyisocyanates wherein one or more of the isocyanato groups are not attached directly to the aromatic ring.

In a non-limiting embodiment of the present invention, the polyisocyanate can include but is not limited to aliphatic or cycloaliphatic diisocyanates, aromatic diisocyanates, cyclic dimers and cyclic trimers thereof, and mixtures thereof. Non-limiting examples of suitable polyisocyanates can include but are not limited to Desmodur N 3300A (hexamethylene diisocyanate trimer) which is commercially available from Bayer; Desmodur N 3400 (60% hexamethylene diisocyanate dimer and 40% hexamethylene diisocyanate trimer).

In a non-limiting embodiment, the polyisocyanate can include dicyclohexylmethane diisocyanate and isomeric mixtures thereof. As used herein and the claims, the term “isomeric mixtures” refers to a mixture of the cis-cis, trans-trans, and cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

In one non-limiting embodiment, the PICM used in this invention can be prepared by phosgenating the 4,4′-methylenebis(cyclohexyl amine) (PACM) by procedures well known in the art such as the procedures disclosed in U.S. Pat. Nos. 2,644,007 and 2,680,127 which are incorporated herein by reference. The PACM isomer mixtures, upon phosgenation, can produce PICM in a liquid phase, a partially liquid phase, or a solid phase at room temperature. The PACM isomer mixtures can be obtained by the hydrogenation of methylenedianiline and/or by fractional crystallization of PACM isomer mixtures in the presence of water and alcohols such as methanol and ethanol.

In a non-limiting embodiment, the isomeric mixture can contain from 10-100 percent of the trans, trans isomer of 4,4′-methylenebis(cyclohexyl isocyanate) (PICM).

In a non-limiting embodiment, the polyisocyanate can include 2,4-tolylene diisocyanate; 2,6-tolylene diisocyanate and mixtures of these isomers (“TDI”).

Additional aliphatic and cycloaliphatic diisocyanates that can be used in alternate non-limiting embodiments of the present invention include 3-isocyanato-methyl-3,5,5-trimethyl cyclohexyl-isocyanate (“IPDI”) which is commercially available from Arco Chemical, and meta-tetramethylxylene diisocyanate (1,3-bis(1-isocyanato-1-methylethyl)-benzene) which is commercially available from Cytec Industries Inc. under the tradename TMXDI.RTM. (Meta) Aliphatic Isocyanate.

As used herein and the claims, the terms aliphatic and cycloaliphatic diisocyanates refer to 6 to 100 carbon atoms linked in a straight chain or cyclized having two diisocyanate reactive end groups. In a non-limiting embodiment of the present invention, the aliphatic and cycloaliphatic diisocyanates for use in the present invention can include TMXDI and compounds of the formula R—(NCO)₂ wherein R represents an aliphatic group or a cycloaliphatic group.

Further non-limiting examples of suitable polyisocyanates can include but are not limited to aliphatic polyisocyanates; ethylenically unsaturated polyisocyanates; alicyclic polyisocyanates; aromatic polyisocyanates wherein the isocyanate groups are not bonded directly to the aromatic ring, e.g., α,α′-xylene diisocyanate; aromatic polyisocyanates wherein the isocyanate groups are bonded directly to the aromatic ring, e.g., benzene diisocyanate; halogenated, alkylated, alkoxylated, nitrated, carbodiimide-modified, urea-modified and biuret-modified derivatives of polyisocyanates thereof; and dimerized and trimerized products of polyisocyanates thereof.

Further non-limiting examples of aliphatic polyisocyanates can include ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexane diisocyanate, decamethylene diisocyanate, 2,4,4,-trimethylhexamethylene diisocyanate, 1,6,11-undecanetriisocyanate, 1,3,6-hexamethylene triisocyanate, 1,8-diisocyanato-4-(isocyanatomethyl)octane, 2,5,7-trimethyl-1,8-diisocyanato-5-(isocyanatomethyl)octane, bis(isocyanatoethyl)-carbonate, bis(isocyanatoethyl)ether, 2-isocyanatopropyl-2,6-diisocyanatohexanoate, lysinediisocyanate methyl ester and lysinetriisocyanate methyl ester.

Examples of ethylenically unsaturated polyisocyanates can include but are not limited to butene diisocyanate and 1,3-butadiene-1,4-diisocyanate. Alicyclic polyisocyanates can include but are not limited to isophorone diisocyanate, cyclohexane diisocyanate, methylcyclohexane diisocyanate, bis(isocyanatomethyl) cyclohexane, bis(isocyanatocyclohexyl)methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane and 2-isocyanatomethyl-2-(3-isocyanatopropyl)-6-(2-isocyanatoethyl)-bicyclo[2.2.1]-heptane.

Examples of aromatic polyisocyanates wherein the isocyanate groups are not bonded directly to the aromatic ring can include but are not limited to bis(isocyanatoethyl)benzene, α,α,α′,α′-tetramethylxylene diisocyanate, 1,3-bis(1-isocyanato-1-methylethyl)benzene, bis(isocyanatobutyl)benzene, bis(isocyanatomethyl)naphthalene, bis(isocyanatomethyl)diphenyl ether, bis(isocyanatoethyl) phthalate, mesitylene triisocyanate and 2,5-di(isocyanatomethyl)furan. Aromatic polyisocyanates having isocyanate groups bonded directly to the aromatic ring can include but are not limited to phenylene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene triisocyanate, naphthalene diisocyanate, methylnaphthalene diisocyanate, biphenyl diisocyanate, ortho-toluidine diisocyanate, ortho-tolylidine diisocyanate, ortho-tolylene diisocyanate, 4,4′-diphenylmethane diisocyanate, bis(3-methyl-4-isocyanatophenyl)methane, bis(isocyanatophenyl)ethylene, 3,3′-dimethoxy-biphenyl-4,4′-diisocyanate, triphenylmethane triisocyanate, polymeric 4,4′-diphenylmethane diisocyanate, naphthalene triisocyanate, diphenylmethane-2,4,4′-triisocyanate, 4-methyldiphenylmethane-3,5,2′,4′,6′-pentaisocyanate, diphenylether diisocyanate, bis(isocyanatophenylether)ethyleneglycol, bis(isocyanatophenylether)-1,3-propyleneglycol, benzophenone diisocyanate, carbazole diisocyanate, ethylcarbazole diisocyanate and dichlorocarbazole diisocyanate.

In alternate non-limiting embodiments of the present invention, polyisothiocyanate or a combination of polyisocyanate and polyisothiocyanate can be used in place of polyisocyanate. In these alternate non-limiting embodiments, isothiocyanate can have at least two isothiocyanate groups.

In a non-limiting embodiment of the present invention, the polyisocyanate for use in the present invention can include polyurethane prepolymer.

In a non-limiting embodiment, polyisocyanate can be reacted with hydroxyl-containing material to form polyurethane prepolymer, and said prepolymer can be reacted with amine-containing material and blowing agent to produce the polyurethane urea of the present invention. In another non-limiting embodiment, polyisocyanate and polyurethane prepolymer can be reacted with hydroxyl-containing material, amine-containing material and blowing agent. In a further non-limiting embodiment, polyisocyanate and polyurethane prepolymer can be reacted with amine-containing material and blowing agent.

Hydroxyl-containing materials are varied and known in the art. Non-limiting examples can include but are not limited to polyols; sulfur-containing materials such as but not limited to hydroxyl functional polysulfides, and SH-containing materials such as but not limited to polythiols; and materials having both hydroxyl and thiol functional groups.

Non-limiting examples of hydroxyl-containing materials for use in the present invention can include but are not limited to polyether polyols, polyester polyols, polycaprolactone polyols, polycarbonate polyols, and mixtures thereof.

Polyether polyols and methods for their preparation are known to one skilled in the art. Many polyether polyols of various types and molecular weight are commercially available from various manufacturers. Non-limiting examples of polyether polyols can include but are not limited to polyoxyalkylene polyols, and polyalkoxylated polyols. Polyoxyalkylene polyols can be prepared in accordance with known methods. In a non-limiting embodiment, a polyoxyalkylene polyol can be prepared by condensing an alkylene oxide, or a mixture of alkylene oxides, using acid- or base-catalyzed addition with a polyhydric initiator or a mixture of polyhydric initiators, such as but not limited to ethylene glycol, propylene glycol, glycerol, and sorbitol. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or stepwise oxyalkylation. Non-limiting examples of such polyoxyalkylene polyols include polyoxyethylene, such as but not limited to polyethylene glycol, polyoxypropylene, such as but not limited to polypropylene glycol.

In a non-limiting embodiment, polyalkoxylated polyols can be represent by the following general formula: 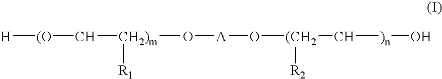
wherein m and n can each be a positive integer, the sum of m and n being from 5 to 70; R₁ and R₂ are each hydrogen, methyl or ethyl; and A is a divalent linking group such as a straight or branched chain alkylene which can contain from 1 to 8 carbon atoms, phenylene, and C₁ to C₉ alkyl-substituted phenylene. The chosen values of m and n can, in combination with the chosen divalent linking group, determine the molecular weight of the polyol.

Polyalkoxylated polyols can be prepared by methods that are known in the art. In a non-limiting embodiment, a polyol such as 4,4′-isopropylidenediphenol can be reacted with an oxirane-containing material such as but not limited to ethylene oxide, propylene oxide and butylene oxide, to form what is commonly referred to as an ethoxylated, propoxylated or butoxylated polyol having hydroxy functionality. Non-limiting examples of polyols suitable for use in preparing polyalkoxylate polyols can include those polyols described in U.S. Pat. No. 6,187,444 B1 at column 10, lines 1-20, which disclosure is incorporated herein by reference.

As used herein and the claims, the term “polyether polyols” can include the generally known poly(oxytetramethylene) diols prepared by the polymerization of tetrahydrofuran in the presence of Lewis acid catalysts such as but not limited to boron trifluoride, tin (IV) chloride and sulfonyl chloride. In a non-limiting embodiment, the polyether polyol can include Terathane™ which is commercially available from DuPont. Also included are the polyethers prepared by the copolymerization of cyclic ethers such as but not limited to ethylene oxide, propylene oxide, trimethylene oxide, and tetrahydrofuran with aliphatic diols such as but not limited to ethylene glycol, 1,3-butanediol, 1,4-butanediol, diethylene glycol, dipropylene glycol, 1,2-propylene glycol and 1,3-propylene glycol. Compatible mixtures of polyether polyols can also be used. As used herein, “compatible” means that the polyols are mutually soluble in each other so as to form a single phase.

A variety of polyester polyols known in the art can be used in the present invention. Suitable polyester polyols can include but are not limited to polyester glycols. Polyester glycols for use in the present invention can include the esterification products of one or more dicarboxylic acids having from four to ten carbon atoms, such as but not limited to adipic, succinic or sebacic acids, with one or more low molecular weight glycols having from two to ten carbon atoms, such as but not limited to ethylene glycol, propylene glycol, diethylene glycol, 1,4-butanediol, neopentyl glycol, 1,6-hexanediol and 1,10-decanediol. Esterification procedures for producing polyester polyols is described, for example, in the article D. M. Young, F. Hostettler et al., “Polyesters from Lactone,” Union Carbide F-40, p. 147.

In a non-limiting embodiment, the polyol for use in the present invention can include polycaprolactone polyols. Suitable polycaprolactone polyols are varied and known in the art. In a non-limiting embodiment, polycaprolactone polyols can be prepared by condensing caprolactone in the presence of difunctional active hydrogen compounds such as but not limited to water or low molecular weight glycols as recited herein. Non-limiting examples of suitable polycaprolactone polyols can include commercially available materials designated as the CAPA series from Solvay Chemical which includes but is not limited to CAPA 2047A, and the TONE™ series from Dow Chemical such as but not limited to TONE 0201.

Polycarbonate polyols for use in the present invention are varied and known to one skilled in the art. Suitable polycarbonate polyols can include those commercially available (such as but not limited to Ravecarb™ 107 from Enichem S.p.A.). In a non-limiting embodiment, the polycarbonate polyol can be produced by reacting an organic glycol such as a diol, described hereinafter and in connection with the glycol component of the polyurethane or polyurethane urea, and a dialkyl carbonate, such as described in U.S. Pat. No. 4,160,853. In a non-limiting embodiment, the polyol can include polyhexamethyl carbonate such as HO—(CH₂)₆—[O—C(O)—O—(CH₂)₆]ₙ—OH, wherein n is an integer from 4 to 24, or from 4 to 10, or from 5 to 7.

In a non-limiting embodiment, the glycol material can comprise low molecular weight polyols such as polyols having a number average molecular weight of less than 500 grams/mole, and compatible mixtures thereof. As used herein, the term “compatible” means that the glycols are mutually soluble in each other so as to form a single phase. Non-limiting examples of these polyols can include but are not limited to low molecular weight diols and triols. In a further non-limiting embodiment, the amount of triol chosen can be such to avoid a high degree of cross-linking in the polyurethane or polyurethane urea. In alternate non-limiting embodiments, the organic glycol can contain from 2 to 16, or from 2 to 6, or from 2 to 10, carbon atoms. Non-limiting examples of such glycols can include but are not limited to ethylene glycol, propylene glycol, diethylene glycol, triethylene glycol, tetraethylene glycol, dipropylene glycol, tripropylene glycol, 1,2-, 1,3- and 1,4-butanediol, 2,2,4-trimethyl-1,3-pentanediol, 2-methyl-1,3-pentanediol, 1,3- 2,4- and 1,5-pentanediol, 2,5- and 1,6-hexanediol, 2,4-heptanediol, 2-ethyl-1,3-hexanediol, 2,2-dimethyl-1,3-propanediol, 1,8-octanediol, 1,9-nonanediol, 1,10-decanediol, 1,4-cyclohexanediol, 1,4-cyclohexanedimethanol, 1,2-bis(hydroxyethyl)-cyclohexane, glycerin, tetramethylolmethane, pentaerythritol, trimethylolethane and trimethylolpropane; and isomers thereof.

In alternate non-limiting embodiments, the hydroxyl-containing material can have a molecular weight of at least 200 grams/mole, or at least 1000 grams/mole, or at least 2000 grams/mole. In alternate non-limiting embodiments, the hydroxyl-containing material can have a number average molecular weight of less than 10,000 grams/mole, or less than 15,000 grams/mole, or less than 20,000 grams/mole, or less than 32,000 grams/mole.

In a non-limiting embodiment, the hydroxyl-containing material for use in the present invention can include teresters produced from at least one low molecular weight dicarboxylic acid, such as adipic acid.

In a non-limiting embodiment, the hydroxyl-containing material can comprise block polymers including blocks of ethylene oxide-propylene oxide and/or ethylene oxide-butylene oxide. In a non-limiting embodiment, the hydroxyl-containing material can comprise a block polymer of the following chemical formula:
HO—(CRRCRR—Yₙ—O)ₐ—(CRRCRR—Yₙ—O)_{b}—(CRRCRR—Yₙ—O)_{c}—H (II)
wherein R can represent hydrogen or C₁-C₆ alkyl; Yₙ can represent C₀-C₆ hydrocarbon; n can be an integer from 0 to 6; a, b, and c can each be an integer from 0 to 300, wherein a, b and c are chosen such that the number average molecular weight of the polyol does not exceed 32,000 grams/mole.

In further alternate non-limiting embodiments, hydroxyl-containing materials such as but not limited to Pluronic.RTM R, Pluronic.RTM, Tetronic.RTM R and Tetronic.RTM Block Copolymer Surfactants, which are commercially available from BASF, can be used as the hydroxyl-containing material in the present invention.

Further non-limiting examples of suitable polyols for use in the present invention can include straight or branched chain alkane polyols, such as but not limited to 1,2-ethanediol, 1,3-propanediol, 1,2-propanediol, 1,4-butanediol, 1,3-butanediol, glycerol, neopentyl glycol, trimethylolethane, trimethylolpropane, di-trimethylolpropane, erythritol, pentaerythritol and di-pentaerythritol; polyalkylene glycols, such as but not limited to diethylene glycol, dipropylene glycol and higher polyalkylene glycols such as but not limited to polyethylene glycols which can have number average molecular weights of from 200 grams/mole to 2,000 grams/mole; cyclic alkane polyols, such as but not limited to cyclopentanediol, cyclohexanediol, cyclohexanetriol, cyclohexanedimethanol, hydroxypropylcyclohexanol and cyclohexanediethanol; aromatic polyols, such as but not limited to dihydroxybenzene, benzenetriol, hydroxybenzyl alcohol and dihydroxytoluene; bisphenols, such as, 4,4′-isopropylidenediphenol; 4,4′-oxybisphenol, 4,4′-dihydroxybenzophenone, 4,4′-thiobisphenol, phenolphthlalein, bis(4-hydroxyphenyl)methane, 4,4′-(1,2-ethenediyl)bisphenol and 4,4′-sulfonylbisphenol; halogenated bisphenols, such as but not limited to 4,4′-isopropylidenebis(2,6-dibromophenol), 4,4′-isopropylidenebis(2,6-dichlorophenol) and 4,4′-isopropylidenebis(2,3,5,6-tetrachlorophenol); alkoxylated bisphenols, such as but not limited to alkoxylated 4,4′-isopropylidenediphenol which can have from 1 to 70 alkoxy groups, for example, ethoxy, propoxy, α-butoxy and β-butoxy groups; and biscyclohexanols, which can be prepared by hydrogenating the corresponding bisphenols, such as but not limited to 4,4′-isopropylidene-biscyclohexanol, 4,4′-oxybiscyclohexanol, 4,4′-thiobiscyclohexanol and bis(4-hydroxycyclohexanol)methane; polyurethane or polyurethane urea polyols, polyester polyols, polyether polyols, poly vinyl alcohols, polymers containing hydroxy functional acrylates, polymers containing hydroxy functional methacrylates, and polymers containing allyl alcohols.

In a non-limiting embodiment, the polyol can be chosen from multifunctional polyols, including but not limited to trimethylolpropane, ethoxylated trimethylolpropane, pentaerythritol.

In alternate non-limiting embodiments, the polyurethane prepolymer can have a number average molecular weight (Mn) of less than 50,000 grams/mole, or less than 20,000 grams/mole, or less than 10,000 grams/mole. The Mn can be determined using a variety of known methods. In a non-limiting embodiment, the Mn can be determined by gel permeation chromatography (GPC) using polystyrene standards.

In alternate non-limiting embodiments, the hydroxyl-containing material for use in the present invention can be chosen from polyether glycols and polyester glycols having a number average molecular weight of at least 200 grams/mole, or at least 300 grams/mole, or at least 750 grams/mole; or no greater than 1,500 grams/mole, or no greater than 2,500 grams/mole, or no greater than 4,000 grams/mole.

In a further non-limiting embodiment, polyether glycols for use in the present invention can include but are not limited to polytetramethylene ether glycol.

In a non-limiting embodiment, the hydroxyl-containing material can include both hydroxyl and thiol groups, such as but not limited to 2-mercaptoethanol, 3-mercapto-1,2-propanediol, glycerin bis(2-mercaptoacetate) and 1-hydroxy-4-mercaptocyclohexane.

In general, polyurethanes and polyurethane prepolymers can be polymerized using a variety of techniques known in the art. In a non-limiting embodiment of the present invention, the polymerization process can include the use of an amine-containing material for curing.

Amine-containing curing agents for use in the present invention are numerous and widely varied. Non-limiting examples of suitable amine-containing curing agents can include but are not limited to aliphatic polyamines, cycloaliphatic polyamines, aromatic polyamines and mixtures thereof. In alternate non-limiting embodiments, the amine-containing curing agent can be a polyamine having at least two functional groups independently chosen from primary amine (—NH₂), secondary amine (—NH—) and combinations thereof. In a further non-limiting embodiment, the amine-containing curing agent can have at least two primary amine groups. In another non-limiting embodiment, the amine-containing curing agent can comprise a mixture of a polyamine and at least one material selected from a polythiol and polyol. Non-limiting examples of suitable polythiols and polyols include those previously recited herein. In still another non-limiting embodiment, the amine-containing curing agent can be a sulfur-containing amine-containing curing agent. A non-limiting example of a sulfur-containing amine-containing curing agent can include Ethacure 300 which is commercially available from Albemarle Corporation.

Suitable amine-containing curing agents for use in the present invention can include but are not limited to materials having the following chemical formula: 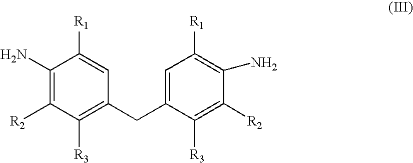
wherein R₁ and R₂ can each be independently chosen from methyl, ethyl, propyl, and isopropyl groups, and R₃ can be chosen from hydrogen and chlorine. Non-limiting examples of amine-containing curing agents for use in the present invention include the following compounds, manufactured by Lonza Ltd. (Basel, Switzerland):
LONZACURE.RTM. M-DIPA: R₁=C₃H₇; R₂=C₃H₇; R₃=H
LONZACURE.RTM. M-DMA: R₁=CH₃; R₂=CH₃; R₃=H
LONZACURE.RTM. M-MEA: R₁=CH₃; R₂=C₂H₅; R₃=H
LONZACURE.RTM. M-DEA: R₁=C₂H₅; R₂=C₂H₅; R₃=H
LONZACURE.RTM. M-MIPA: R₁=CH₃; R₂=C₃H₇; R₃=H
LONZACURE.RTM. M-CDEA: R₁=C₂H₅; R₂=C₂H₅; R₃=Cl
   wherein R₁, R₂ and R₃ correspond to the aforementioned chemical formula.

In a non-limiting embodiment, the amine-containing curing agent can include but is not limited to a diamine curing agent such as 4,4′-methylenebis(3-chloro-2,6-diethylaniline), (Lonzacure.RTM. M-CDEA), which is available in the United States from Air Products and Chemical, Inc. (Allentown, Pa.). In alternate non-limiting embodiments, the amine-containing curing agent for use in the present invention can include 2,4-diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100; dimethylthiotoluenediamine (DMTDA), which is commercially available from Albemarle Corporation under the trade name Ethacure 300; 4,4′-methylene-bis-(2-chloroaniline) which is commercially available from Kingyorker Chemicals under the trade name MOCA. DETDA can be a liquid at room temperature with a viscosity of 156 cPs at 25° C. DETDA can be isomeric, with the 2,4-isomer range being from 75 to 81 percent while the 2,6-isomer range can be from 18 to 24 percent.

Non-limiting examples of amine-containing curing agents can include ethyleneamines. Suitable ethyleneamines can include but are not limited to ethylenediamine (EDA), diethylenetriamine (DETA), triethylenetetramine (TETA), tetraethylenepentamine (TEPA), pentaethylenehexamine (PEHA), piperazine, morpholine, substituted morpholine, piperidine, substituted piperidine, diethylenediamine (DEDA), and 2-amino-1-ethylpiperazine. In alternate non-limiting embodiments, the amine-containing curing agent can be chosen from one or more isomers of C₁-C₃ dialkyl toluenediamine, such as but not limited to 3,5-dimethyl-2,4-toluenediamine, 3,5-dimethyl-2,6-toluenediamine, 3,5-diethyl-2,4-toluenediamine, 3,5-diethyl-2,6-toluenediamine, 3,5-diisopropyl-2,4-toluenediamine, 3,5-diisopropyl-2,6-toluenediamine, and mixtures thereof. In alternate non-limiting embodiments, the amine-containing curing agent can be methylene dianiline or trimethyleneglycol di(para-aminobenzoate).

In alternate non-limiting embodiments of the present invention, the amine-containing curing agent can include one of the following general structures:

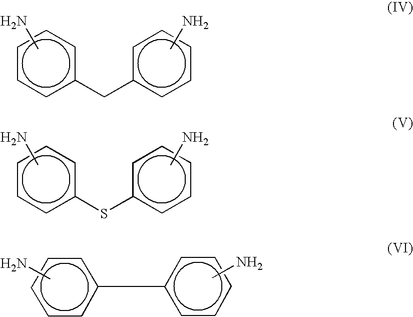

In further alternate non-limiting embodiments, the amine-containing curing agent can include one or more methylene bis anilines which can be represented by the general formulas VII-XI, one or more aniline sulfides which can be represented by the general formulas XII-XVI, and/or one or more bianilines which can be represented by the general formulas XVII-XX,

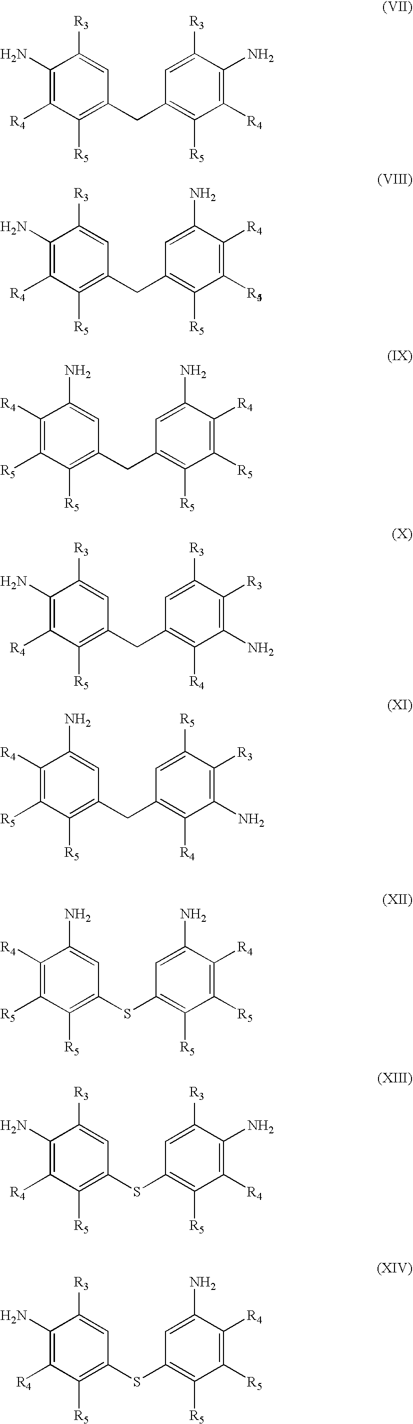

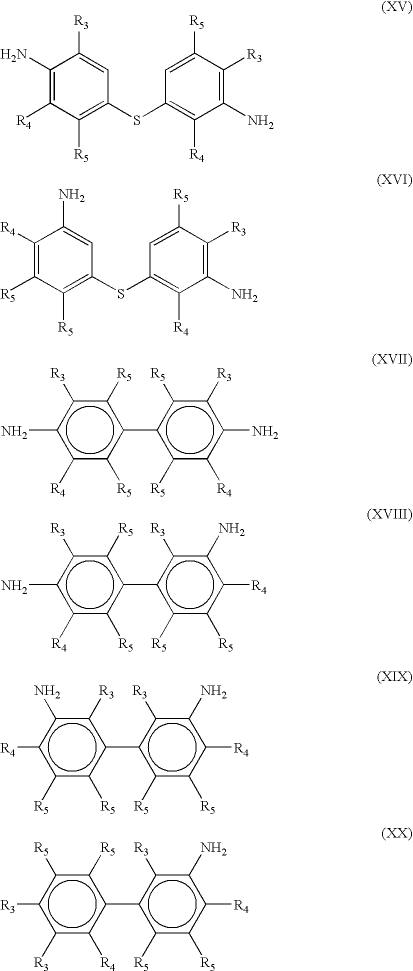

wherein R₃ and R₄ can each independently represent C₁ to C₃ alkyl, and R₅ can be chosen from hydrogen and halogen, such as but not limited to chlorine and bromine. The diamine represented by general formula VII can be described generally as a 4,4′-methylene-bis(dialkylaniline). Suitable non-limiting examples of diamines which can be represented by general formula VII include but are not limited to 4,4′-methylene-bis(2,6-dimethylaniline), 4,4′-methylene-bis(2,6-diethylaniline), 4,4′-methylene-bis(2-ethyl-6-methylaniline), 4,4′-methylene-bis(2,6-diisopropylaniline), 4,4′-methylene-bis(2-isopropyl-6-methylaniline) and 4,4′-methylene-bis(2,6-diethyl-3-chloroaniline).

In a further non-limiting embodiment, the amine-containing curing agent can include materials which can be represented by the following general structure (XXI):

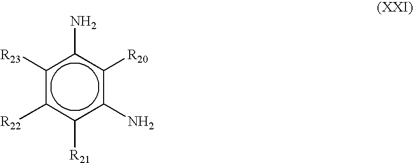

where R₂₀, R₂₁, R₂₂, and R₂₃ can be independently chosen from H, C₁ to C₃ alkyl, CH₃—S— and halogen, such as but not limited to chlorine or bromine. In a non-limiting embodiment of the present invention, the amine-containing curing agent which can be represented by general Formula XXI can include diethyl toluene diamine (DETDA) wherein R₂₃ is methyl, R₂₀ and R₂₁ are each ethyl and R₂₂ is hydrogen. In a further non-limiting embodiment, the amine-containing curing agent can include 4,4′-methylenedianiline.

In alternate non-limiting embodiments, the amine-containing material, blowing agent, polyisocyanate and hydroxyl-containing materials can be mixed using a variety of methods and equipment, such as but not limited to an impeller or extruder. In a non-limiting embodiment, the mixing equipment can include a mechanical stirrer operating at low pressure such as less than 20 bar. In another non-limiting embodiment, the components can be mixed by impingement mixing wherein the components are injected at high velocity and pressure into a mixing chamber, and the components are then mixed in the chamber by kinetic energy. In this embodiment, the components are typically injected at a velocity of from 100 to 200 meters per second, and a pressure of from 20 to 3000 bar.

In alternate non-limiting embodiments, polyisocyanate can be contained in a first feed of a mixing unit, the amine-containing material and hydroxyl-containing material in a second feed and the blowing agent in a third feed; or the second feed can include the amine-containing material, blowing agent and hydroxyl-containing material. In further alternate non-limiting embodiments, polyurethane prepolymer and optional polyisocyanate can be contained in a first feed of a mixing unit, the amine-containing material and optional hydroxyl-containing material in a second feed and blowing agent in a third feed; or the second feed can include the amine-containing material, blowing agent and optional hydroxyl-containing material.

In another non-limiting embodiment, the polyurethane urea can be prepared by a one-pot process by combining polyisocyanate, hydroxyl-containing material, amine-containing material and blowing agent. In still another non-limiting embodiment, the polyurethane urea can be prepared by combining polyurethane prepolymer, optional polyisocyanate, optional hydroxyl-containing material, amine-containing material and blowing agent.

In a non-limiting embodiment of the present invention, a mixing unit having three feeds can be used in combining the polyisocyanate and/or polyurethane prepolymer, hydroxyl-containing material, amine-containing material and blowing agent. The ingredients can be added into the feeds using a variety of configurations. In alternate non-limiting embodiments, the first feed of a mixing unit can contain polyisocyanate and/or polyurethane prepolymer and the second feed can contain hydroxyl-containing material, amine-curing agent and blowing agent; or the second feed can contain hydroxyl-containing material and amine-containing material, and a third feed can contain blowing agent; or the second feed can contain amine-containing material, and the third feed can contain hydroxyl-containing material and blowing agent; or the second feed can contain hydroxyl-containing material, and the third feed can contain amine-containing material and blowing agent. In further non-limiting embodiments, wherein polyurethane prepolymer is present in a first feed, the presence of hydroxyl-containing material in another feed is optional.

A blowing agent can be used in the present invention to form cells at least partially filled with gas within the polyurethane urea material. In a non-limiting embodiment, the cells are substantially uniformly distributed throughout the polyurethane urea material. The size of the cells can vary widely. In alternate non-limiting embodiments, a cell can be from at least 1 micron, or at least 20 microns, or at least 30 microns, or at least 40 microns; to less than 1000 microns, or less than 500 microns or less than 100 microns.

In a non-limiting embodiment, the blowing agent can be water. The water can react in-situ with isocyanate (NCO) to produce carbon dioxide. In a further non-limiting embodiment, one or more auxiliary blowing agents can be used in combination with the blowing agent. Suitable auxiliary blowing agents for use in the present invention can vary widely and can include substances which can be substantially volatile at the reaction temperature. The auxiliary blowing agent can be selected from those known in the art. Non-limiting examples can include but are not limited to acetone, ethyl acetate, halogen substituted alkanes such as methylene chloride, chloroform, ethylidene chloride, vinylidene chloride, monofluorotrichloromethane, chlorodifluoromethane, dichlorodifluoromethane, dichloromonofluoromethane, butane, pentane, cyclopentane hexane, heptane, and diethylether.

The amount of blowing agent used in the present invention can vary. In alternate non-limiting embodiments, the blowing agent can be present in an amount such that a selected or desired density and/or pore volume of the polishing pad can be achieved. In alternate non-limiting embodiments, the density can be from 0.50 to 1.10 g/cc; the pore volume can be from 5% to 55% based on the volume of polyurethane urea material. Density can be measured using a variety of methods known to one of ordinary skill in the art. The density values recited herein are determined in accordance with ASTM 1622-88. Pore volume can also be measured using a variety of methods known to a skilled artisan. The pore volume values recited herein are determined in accordance with ASTM D 4284-88, using an Autopore III mercury porosimeter manufactured by Micromeritics. In a further non-limiting embodiment, the amount of blowing agent can be from 0 to 5% by weight of the reaction mixture.

In a non-limiting embodiment, the amine-containing material can contain at least a small concentration of residual moisture or water sufficient to act as the blowing agent.

In another non-limiting embodiment, a urethane-forming catalyst and/or blowing catalyst can be used in the present invention to enhance the reaction of the polyurethane urea-forming materials, and/or accelerate the reaction with blowing agent. In a further non-limiting embodiment, one or more materials can be used wherein each material can exhibit characteristics of a urethane-forming and blowing catalyst.

Suitable urethane-forming catalysts can vary, for example, suitable urethane-forming catalysts can include those catalysts that are known in the art to be useful for the formation of urethane by reaction of the NCO and OH-containing materials. Non-limiting examples of suitable catalysts can be chosen from the group of Lewis bases, Lewis acids and insertion catalysts as described in Ullmann's Encyclopedia of Industrial Chemistry, 5^{th} Edition, 1992, Volume A21, pp. 673 to 674. In a non-limiting embodiment, the catalyst can be a stannous salt of an organic acid, such as but not limited to stannous octoate, dibutyl tin dilaurate, dibutyl tin diacetate, dibutyl tin mercaptide, dibutyl tin dimaleate, dimethyl tin diacetate, dimethyl tin dilaurate, and mixtures thereof. In alternate non-limiting embodiments, the catalyst can be zinc octoate, bismuth, or ferric acetylacetonate.

A wide variety of blowing catalysts that are known in the art and can be used in the present invention. Non-limiting examples of suitable blowing catalysts can include tertiary amines such as but not limited to 1,4-diazabicyclo[2.2.2]octane, bis-2-dimethyl aminoethyl ether, pentamethyldiethylene triamine, triethylamine, triisopropylamine, N-methylmorpholine and N,N-dimethylbenzylamine. Such suitable tertiary amines are disclosed in U.S. Pat. No. 5,693,738 at column 10, lines 6-38, the disclosure of which is incorporated herein by reference. Tertiary amine catalysts may also include those containing hydroxyl functionality such as N,N-dimethylethanolamine, 2-(2-dimethylaminoethoxy-)ethanol, N,N,N′-trimethyl-N′-hydroxyethyl-bisaminoether, N,N-(dimethyl)-N,N′-diisopropanol-1,3-propanediamine, and N,N-bis-(3-dimethylaminopropyl)-N-isopropanolamine.

In a non-limiting embodiment the catalyst can be chosen from phosphines, tertiary ammonium salts and tertiary amines, such as but not limited to tributyl phosphine, triethylamine; triisopropylamine and N,N-dimethylbenzylamine. Additional non-limiting examples of suitable tertiary amines are disclosed in U.S. Pat. No. 5,693,738 at column 10 lines 6 through 38, the disclosure of which is incorporated herein by reference.

In another non-limiting embodiment, a surfactant can be present during polymerization. Surfactants can influence the formation and stabilization of the at least partially gas-filled cells. In a non-limiting embodiment, the surfactant can be selected such that it has high surface activity for nucleation and stabilization of the cells. In another non-limiting embodiment, the surfactant can be selected such that it has good emulsifying abilities for a blowing agent. Suitable surfactants for use in the present invention are wide and varied. In a non-limiting embodiment, a silicone surfactant can be used. The silicone surfactant can be selected from siloxane-polyoxyalkylene copolymer surfactants. Non-limiting examples of such surfactants can include but are not limited to polydimethylsiloxane-polyoxyalkylene block copolymers which are available from GE Silicons Incorporated under the designations Niax RTM. Silicone L-1800, L-5420 and L-5340; Dow Corning Corporation under the designations DC-193, DC-5357 and DC-5315; and Goldschmidt Chemical Corporation under the designations B-8404 and B-8407.

In a further non-limiting embodiment, the siloxane-polyoxyalkylene copolymer surfactant can be represented by the following general formula,

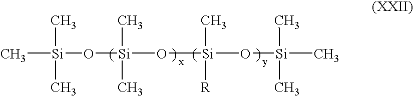

wherein x is a number from 1 to 150, y is a number of from 1 to 50, the ratio of x:y is from 10:1 to 1:1 and R is an alkyl alkoxylate. With reference to the general formula I, x can be from 10 to 50, or from 10 to 42, or from 13 to 42; and y can be from 2 to 20, or from 5 to 20, or from 7 to 20, or from 7 to 10. The ratio of x:y can be between 2.4 and 6.8.

R can be an alkyl alkoxylate which can be represented by the following general formula XXIII
R′O(C₂H₄O)ₘ(C₃H₆O)ₙH (XXIII)

wherein R′ is an alkylene group containing from 3 to 6 carbon atoms, m is a number of from 5 to 200, and n is a number of from 0 to 20, or from 2 to 18. The molecular weight of R is in the range of from 400 to 4000, and the molecular weight of the surfactant represented by general formula XXII can be from 6,000 to 50,000.

The siloxane-polyoxyalkylene copolymer surfactant can be prepared as described in U.S. Pat. No. 5,691,392, column 3, line 25 through column 4, line 18, which is incorporated herein by reference.

The amount of surfactant useful in the present invention can vary widely. In alternate non-limiting embodiments, the amount is such that the surfactant is from 0.001% to 10%, or 0.01% to 1%, or from 0.05% to 0.5% by weight of the reaction mixture.

In another non-limiting embodiment, a nucleating agent can be used during polymerization in preparing the polyurethane urea of the present invention. Suitable nucleating agents for use in the present invention can include materials which enhance the generation of relatively small substantially uniform cells. The nucleating agent can be selected from those known in the art. Non-limiting examples can include but are not limited to relatively small size polymer particles such as but not limited to polypropylene, polyethylene, polystyrene, polyurethane, polyester, and polyacrylates. The amount of nucleating agent used can vary widely. In general, the nucleating agent can be used in an amount which is effective to generate said cells. In alternate non-limiting embodiments, the nucleating agent can be present in an amount of from 0.01% to 1.00%, or from 0.05% to 0.5%, by weight of the reaction mixture.

In a non-limiting embodiment, feeds containing polyisocyanate and/or polyurethane prepolymer, hydroxyl-containing material, amine-containing material, blowing agent and any optional additives can be directed into a mixing unit. Optional additives can include a wide variety of additives known to one having ordinary skill in the art. Non-limiting examples can include but are not limited to antioxidants, hindered amine UV stabilizers, UV absorbers, plasticizers, internal mold release agents, dyes and pigments. In further alternate non-limiting embodiments, any or all of the feeds can be heated to reduce the viscosity of the feeds and/or the resulting mixture. The reaction mixture exiting the mixing unit then can be poured into an open cavity to form a polishing pad. In a non-limiting embodiment, the cavity can be controlled to a temperature of from 22° C. to 150° C., or from 60° C. to 110° C.

The polishing pad of the present invention can have one or more work surfaces, wherein “work surface” as used herein and the claims refers to a surface of the pad that can come into contact with the surface of the article that is to be polished and polishing slurry. In a non-limiting embodiment, the article to be polished can be a silicon wafer. In further non-limiting embodiments, the work surface of the polishing pad can have surface features such as but not limited to channels, grooves, perforations and combinations thereof.

Surface features can be incorporated into the work surface of the polishing pad by means that are known to those of ordinary skill in the art. In a non-limiting embodiment, the work surface of the pad can be mechanically modified, for example, by abrading or cutting. In another non-limiting embodiment, surface features can be incorporated into the work surface of the pad during the molding process, for example, by providing at least one interior surface of the mold with raised features that can be imprinted into the work surface of the pad during its formation. Surface features can be distributed in the form of random or uniform patterns across the work surface of the polishing pad. Non-limiting examples of surface feature patterns can include but are not limited to spirals, circles, squares, cross-hatches and waffle-like patterns.

In a non-limiting embodiment, the polyurethane urea can comprise an abrasive particulate material. The abrasive particulate material can be distributed substantially uniformly or non-uniformly throughout the polyurethane urea. In alternate non-limiting embodiments, the abrasive particulate material can be present in an amount of less than 70 percent by weight, or at least 5 percent by weight, or from 5 percent to 65 percent by weight, based on the total weight of the polishing pad.

In alternate non-limiting embodiments, the abrasive particulate material can be in the form of individual particles, aggregates of individual particles, or a combination of individual particles and aggregates. In further alternate non-limiting embodiments, the shape of the abrasive particulate material can include but is not limited to spheres, rods, triangles, pyramids, cones, regular cubes, irregular cubes, and mixtures and/or combinations thereof.

In general, the average particle size of the abrasive particulate material can vary widely. In alternate non-limiting embodiments, the average particle size can be at least 0.001 micron, or at least 0.01 micron, or at least 0.1 micron. In further alternate non-limiting embodiments, the average particle size of the abrasive particulate material can be less than 50 microns, or less than 10 microns, or less than 1 micron. In a non-limiting embodiment, the average particle size of the abrasive particulate material can measured along the longest dimension of the particle.

Non-limiting examples of suitable abrasive particulate materials for use in the present invention can include aluminum oxide, such as but not limited to gamma alumina, fused aluminum oxide, heat treated aluminum oxide, white fused aluminum oxide, and sol gel derived alumina; silicon carbide, such as but not limited to green silicon carbide and black silicon carbide; titanium diboride; boron carbide; silicon nitride; tungsten carbide; titanium carbide; diamond; boron nitride, such as but not limited to cubic boron nitride and hexagonal boron nitride; garnet; fused alumina zirconia; silica, such as but not limited to fumed silica; iron oxide; cromia; ceria; zirconia; titania; tin oxide; manganese oxide; and mixtures thereof. In a further non-limiting embodiment, the abrasive particulate material can be chosen from aluminum oxide, silica, cerium oxide, zirconia and mixtures thereof.

In a non-limiting embodiment, the abrasive particulate material used in the present invention can have a surface modifier thereon. Non-limiting examples of suitable surface modifiers can include surfactants, coupling agents and mixtures thereof. In a non-limiting embodiment, surfactants can be used to improve the dispersibility of the abrasive particles in the polyurethane urea. In another non-limiting embodiment, coupling agents can be used to enhance binding of the abrasive particles to the matrix of the polyurethane urea. In further non-limiting embodiments, the surface modifier can be present in an amount of less than 25 percent by weight, or from 0.5 to 10 percent by weight, based on the total weight of the abrasive particulate material and surface modifier.

Non-limiting examples of suitable surfactants for use as surface modifiers in the present invention can include anionic, cationic, amphoteric and nonionic surfactants, such as but not limited to metal alkoxides, polalkylene oxides, salts of long chain fatty carboxylic acids. Non-limiting examples of suitable coupling agents for use in the present invention can include silanes, such as but not limited to organosilanes, titanates and zircoaluminates. In a non-limiting embodiment, the coupling agent can include SILQUEST Silanes A-174 and A-1230, which are commercially available from Witco Corporation.

The polishing pad of the present invention can have shapes chosen from but not limited to circles, ellipses, squares, rectangles and triangles. In a non-limiting embodiment, the polishing pad can be in the form of a continuous belt. The polishing pads according to the present invention can have a wide range of sizes and thicknesses. In a non-limiting embodiment, a circular polishing pad can have a diameter ranging from 3.8 cm to 137 cm. In a further non-limiting embodiment, the thickness of the polishing pad can vary from 0.5 mm to 5 mm.

In a non-limiting embodiment, the polishing pad of the present invention can have a density of from 0.5 grams per cubic centimeter (g/cc) to 1.1 g/cc as measured by ASTM 1622-88. In another non-limiting embodiment, the polishing pad can have a Shore A Hardness value of at least 80, or from 85 to 98, and Shore D Hardness value of at least 35, or 85 or less, or from 45 to 80, as determined in accordance with ASTM D 2240.

While not intending to be bound by any theory, it is believed that when in use, while polishing or planarizing the surface of a silicon wafer, the porosity of the work surface of the polishing pad of the present invention can remain substantially constant. As the work surface of the polishing pad is worn away during, for example a polishing or pad conditioning process, new surface pores are formed as those embedded pores residing proximately below the work surface are exposed. Further, as the work surface of the polishing pad is worn away during the polishing process, the gas contained within the at least partially gas-filled cells can be exposed. The gas can be released into the work environment and the remaining void(s) can be at least partially filled with polishing slurry.

In a non-limiting embodiment, the polishing pad of the present invention can be used without a sub-pad, and can be placed directly on the platen of a motorized polishing tool, machine, or apparatus. In an alternate embodiment, the polishing pad of the present invention can be included in a polishing pad assembly, wherein at least one backing sheet can be adhered to the back surface of the polishing pad. In a non-limiting embodiment, a polishing pad assembly can comprise:
(a) a polishing pad having a work surface and a back surface;
(b) a backing sheet having an upper surface and a lower surface; and
(c) an adhesive means interposed between and in contact with the back surface of said polishing pad and the upper surface of said backing sheet.

In a non-limiting embodiment, the backing sheet of the polishing pad assembly can be rigid or flexible, and can support or stabilize or cushion the polishing pad during polishing operations. The backing sheet can be fabricated from materials that are known to the skilled artisan. In alternate non-limiting embodiments, the backing sheet can be fabricated from organic polymeric materials, such as but not limited to polyesters, such as polyethylene terephthalate sheet, and polyolefins, such as polyethylene sheet and polypropylene sheet.

In another non-limiting embodiment, the backing sheet of the polishing pad assembly of the present invention can be a release sheet, which can be peeled away from the adhesive means, thereby allowing the pad to be adhered to another surface, for example, the platen of a polishing apparatus, by means of the exposed adhesive means. In general, release sheets are known to those of ordinary skill in art. In a non-limiting embodiment, the release sheet can be fabricated from paper or organic polymeric materials, such as but not limited to polyethylene terephthalate sheet, polyolefins, for example, polyethylene sheet and polypropylene sheet, and fluorinated polyolefins, for example, polytetrafluoroethylene. In a further non-limiting embodiment, the upper surface of the release sheet can comprise a release coating thereon that can be in contact with the adhesive means. Release coatings are well known to the skilled artisan. Non-limiting examples of release coatings can include fluorinated polymers and silicones.

The adhesive means of the polishing pad assembly can be selected from an adhesive assembly or an adhesive layer. An adhesive layer can be applied according to known methods. In a non-limiting embodiment, the adhesive layer can be applied to the back surface of the polishing pad and/or the upper surface of the backing sheet, prior to pressing the polishing pad and backing sheet together. Non-limiting examples of adhesive layers can include contact adhesives, thermoplastic adhesives, and curable adhesives, such as but not limited to thermosetting adhesives.

In another non-limiting embodiment, an adhesive assembly can comprise an adhesive support sheet interposed between an upper adhesive layer and a lower adhesive layer. The upper adhesive layer of the adhesive assembly can be in contact with the back surface of the polishing pad, and the lower adhesive layer can be in contact with the upper surface of the backing sheet. Non-limiting examples of adhesive support sheets can be fabricated from an organic polymeric material, such as but not limited to polyesters, for example, polyethylene terephthalate sheet, and polyolefins, for example, polyethylene sheet and polypropylene sheet. In a further non-limiting embodiment, the upper and lower adhesive layers of the adhesive assembly can be chosen from those adhesives as recited previously herein with regard to the adhesive layer. In a non-limiting embodiment, the upper and lower adhesive layers can each be contact adhesives. In a further non-limiting embodiment, the adhesive assembly can be a two-sided or double-coated tape, such as but not limited to double-coated film tapes, which can be commercially obtained from 3M, Industrial Tape and Specialties Division.

In a non-limiting embodiment, the polishing pad of the present invention can be used in combination with polishing fluid, such as polishing slurry, which is known in the art. During polishing, the polishing fluid can be interposed between the work surface of the pad and the surface of the substrate to be polished. In a non-limiting embodiment, the polishing steps can include moving the polishing pad relative to the substrate being polished. Non-limiting examples of suitable polishing fluids for use in the present invention can include slurries comprising abrasive particles. Non-limiting examples of suitable abrasives can include particulate cerium oxide, particulate alumina, and particulate silica. Non-limiting examples of commercial slurries for use in polishing semiconductor substrates can include ILD 1200 and ILD1300 which are commercially available from Rodel, Incorporated; and Semi-Sperse AM100 and Semi-Sperse 12 which are commercially available from Cabot Microelectronics Materials Division.

In a non-limiting embodiment, the polishing pad can be at least partially connected to a second layer. In another embodiment, the polishing pad can be at least partially connected to a second layer and the second layer can be at least partially connected to a sub-pad. As used herein and the claims, “connected to” means to link together or place in relationship either directly, or indirectly by one or more intervening materials. In a non-limiting embodiment, the sub-pad can be at least partially connected to the polishing pad by means of the second layer. In a further non-limiting embodiment, the sub-pad can be at least partially connected to the second layer by means of an adhesive and the second layer can be at least partially connected to the polishing pad by means of an adhesive. Suitable adhesives can include those previously described herein. In another non-limiting embodiment, the second layer can comprise an adhesive assembly. The adhesive assembly can include those which have been previously described herein.

The second layer can include a variety of materials known in the art. The second layer can be selected from substantially non-volume compressible polymers and metallic films and foils. As used herein and the claims, “substantially non-volume compressible” means that the volume can be reduced by less than 1% when a load of 20 psi is applied.

Non-limiting examples of substantially non-volume compressible polymers can include polyolefins, such as but not limited to low density polyethylene, high density polyethylene, ultra-high molecular weight polyethylene and polypropylene; polyvinylchloride; cellulose-based polymers, such as but not limited to cellulose acetate and cellulose butyrate; acrylics; polyesters and co-polyesters, such as but not limited to PET and PETG; polycarbonates; polyamides, such as but not limited to nylon 6/6 and nylon 6/12; and high performance plastics, such as but not limited to polyetheretherketone, polyphenylene oxide, polysulfone, polyimide, and polyetherimide; and mixtures thereof.

Non-limiting examples of metallic films can include but are not limited to aluminum, copper, brass, nickel, stainless steel, and combinations thereof.

In a further non-limiting embodiment, the second layer can include an adhesive means selected from those previously described herein.

The thickness of the second layer can vary. In alternate non-limiting embodiments, the second layer can have a thickness of at least 0.0005, or at least 0.0010; or 0.0650 inches or less, or 0.0030 inches or less.

In a non-limiting embodiment, the second layer can be flexible to enhance or increase the uniformity of contact between the polishing pad and the surface of the substrate being polished. A consideration in selecting the material for the second layer can be the capability of a material to provide compliant support to the work surface of the polishing pad such that the polishing pad substantially conforms to the macroscopic contour or long-term surface of the device being polished. A material having said capability can be desirable for use as the second layer in the present invention.

The flexibility of the second layer can vary. The flexibility can be determined using a variety of conventional techniques known in the art. As used herein and the claims the term “flexibility” (F) refers to the inverse relationship of the second layer thickness cubed (t³) and the flexural modulus of the second layer material (E), i.e. F=1/t³E. In alternate non-limiting embodiments, the flexibility of the second layer can be at least 0.5 in⁻¹lb⁻¹; or at least 100 in⁻¹lb⁻¹; or from 1 in⁻¹lb⁻¹ to 100 in⁻¹lb⁻¹.

In a non-limiting embodiment, the second layer can have a compressibility which allows the polishing pad to substantially conform to the surface of the article to be polished. The surface of a microelectronic substrate, such as a semiconductor wafer, can have a “wave” contour as a result of the manufacturing process. It is contemplated that if the polishing pad cannot adequately conform to the “wave” contour of the substrate surface, the uniformity of the polishing performance can be degraded. For example, if the pad substantially conforms the ends of the “wave”, but cannot substantially conform and contact the middle portion of the “wave”, only the ends of the “wave” can be polished or planarized and the middle portion can remain substantially unpolished or unplanarized.

The compressibility of the second layer can vary. The term “compressibility” refers to the percent volume compressibility measurement when a load of 20 psi is applied. In alternate non-limiting embodiments, the percent volume compressibility of the second layer can be at least one percent; or three percent or less; or from one to three percent. The percent volume compressibility can be determined using a variety of conventional methods known in the art.

In a non-limiting embodiment, the second layer is substantially non-volume compressible.

In another non-limiting embodiment, the second layer can distribute the compressive forces experienced by the polishing pad over a larger area of a sub-pad.

In a further non-limiting embodiment, a sub-pad can be used with a polishing pad to increase the uniformity of contact between the polishing pad and the surface of the substrate which is being polished. The sub-pad can be made of a compressible material capable of imparting even pressure to the work surface of the polishing pad. Non-limiting examples of suitable sub-pads can include but are not limited to polyurethane or polyurethane urea impregnated felt, and foam sheet made of natural rubber, synthetic rubber, thermoplastic elastomer, or combinations thereof.

In alternate non-limiting embodiments, the material of the sub-pad can be foamed or blown to produce a porous structure. The porous structure can be open cell, closed cell, or combinations thereof.

Non-limiting examples of synthetic rubbers can include neoprene rubber, silicone rubber, chloroprene rubber, ethylene-propylene rubber, butyl rubber, polybutadiene rubber, polyisoprene rubber, EPDM polymers, styrene-butadiene copolymers, copolymers of ethylene and ethyl vinyl acetate, neoprene/vinyl nitrile rubber, neoprene/EPDM/SBR rubber, and combinations thereof. Non-limiting examples of thermoplastic elastomers can include polyurethanes such as those based on polyethers and polyesters, and copolymers thereof. Non-limiting examples of foam sheet can include ethylene vinyl acetate sheets and polyethylene foam sheets; polyurethane foam sheets and polyolefin foam sheets, such as but not limited to those which are available from Rogers Corporation, Woodstock, Conn.

In a further non-limiting embodiment, the sub-pad can include non-woven or woven fiber mat, and combinations thereof; such as but not limited to polyolefin, polyester, polyamide, or acrylic fibers, which have been impregnated with a resin. The fibers can be staple or substantially continuous in the fiber mat. Non-limiting examples can include but are not limited to non-woven fabric impregnated with polyurethane, such as polyurethane impregnated felt. A non-limiting example of a commercially available non-woven sub-pad can be Suba™ IV, from Rodel, Inc. Newark Del.

The thickness of the sub-pad can vary. In general, the sub-pad thickness should be such that the stacked pad is not too thick. A stacked pad which is too thick can be difficult to place on and take off of the planarization equipment. Thus, in a non-limiting embodiment, the thickness of the sub-pad can be from 0.2 to 2 mm.

In a non-limiting embodiment, the polishing pad of the present invention can at least partially connected to a sub-pad, and the sub-pad can function as the bottom layer of the pad which can be attached to the platen of the polishing apparatus. In a further non-limiting embodiment, the sub-pad is at least partially connected to the polishing pad using an adhesive material selected from those previously described herein.

The present invention is more particularly described in the following examples, which are intended to be illustrative only, since numerous modifications and variations therein will be apparent to those skilled in the art. Unless otherwise specified, all parts and all percentages are by weight.

### EXAMPLES

### Example 1

### Polyurethane Urea Sheet

A mixture was prepared by adding 33.6 grams of Lonzacure MCDEA, 12.0 grams of Versalink P650, 0.73 grams of Niax L1800 and 0.30 grams of Lanco PP1362D to an aluminum pan. This mixture was heated on a hot plate and mixed with a spatula to form a substantially uniform fluid having a temperature of 100° C. While still warm, the mixture was transferred to an 8-ounce glass jar. Water (0.74 grams) was added and mixed substantially uniformly with a propeller stirrer at 800 rpm for 10 seconds. Stirring was stopped and 100.0 grams of Airthane PHP-75D and 0.74 grams of Desmodur N 3300A were added. Stirring was continued at 800 rpm for a period of 25 seconds. The mixture was then poured onto a 12″×12″ glass plate, which had previously been treated with a mold release agent (EXTND 19W from Axel Plastics Research Laboratories, Inc., NY), at a temperature of 60° C. The mixture was drawn to a thickness of approximately 0.125″ using a stainless steel drawdown bar. The glass plate with mixture was placed in an oven at 60° C. for 2 hours. The foamed polymer sheet was then removed from the glass plate and cured in an oven at 110° C. for 18 hours. The product was then allowed to cool to ambient temperature.

The ingredients listed above were obtained as follows:

LONZACURE MCDEA diamine curative was obtained from Air Products and Chemicals, Inc.; which describes it as methylene bis(chlorodiethylanaline).

VERSALINK P-650 poly(tetramethylene glycol) diamine curative was obtained from Air Products and Chemicals, Inc.

NIAX Silicone L-1800, was obtained from GE Silicones.

Lanco PP1362D micronized modified polypropylene wax, was obtained from The Lubrizol Corporation.

AIRTHANE PHP-75D prepolymer, was obtained from Air Products and Chemicals, Inc.; which describes it as the isocyanate functional reaction product of toluene diisocyanate and poly(tetramethylene glycol).

DESMODUR N 3300 aliphatic polyisocyanate, was obtained from Bayer Corporation, Coatings and Colorants Division, which describes it as a polyfunctional aliphatic isocyanate resin based on hexamethylene diisocyanate.

The density, shore D hardness, tensile strength and elongation of the product were measured. The density in grams per cubic centimeter was determined in accordance with ASTM D 1622-88. The shore D hardness was determined in accordance with ASTM D 2240-91 using a type D durometer, model 307L from Pacific Transducer Corporation, CA. Tensile strength and elongation were determined in accordance with ASTM D 412-87 using an INSTRON model 4204 testing machine with a crosshead speed of 20 inches/minute and with extensiometer accessory. The resultant values of each are shown below.
Density=0.86 g/cc
Shore D Hardness=58
Tensile Strength=3127 psi
Elongation=143%

### Example 2

54.00 kilograms of Airthane PHP-75D were charged into a first tank and held at 140° F. and 80 psi of nitrogen pressure with a low agitation. A mixture was prepared by melting 32.23 kilograms of Lonzacure MCDEA, and then adding with stirring 11.52 kilograms of Versalink P650 and 692 grams of Niax L1800. This mixture was brought to a temperature of 180° F., and then 288 grams of Lanco PP1362D were added and stirred until uniformly dispersed. Next, 680 grams of water were added with rapid stirring. This curative mixture was then charged into a second tank and held at 180° F. and 40 psi of nitrogen pressure. The fluids of the first and second tanks were fed into a mixer, by constant delivery pumps, at a weight ratio of 211 grams from the first tank: 100 grams from the second tank. The fluids were mixed under high agitation and dispensed into an open circular mold having a diameter of 25 inches and a thickness of 0.25 inches, which had been preheated to 158° F. The open mold was placed in an oven at 230° F. for 20 minutes. After this time, the product was removed from the mold. Curing was continued for 18 hours at 230° F. The product was then allowed to cool to ambient temperature.

A circular pad having a 22.5″ diameter was cut from the sheet using a press with cutting die. The pad was then cut to a thickness of 0.050 inches and the upper and lower surfaces of the pad were made parallel using a milling machine.

The following density and shore D hardness values were determined in accordance with the description provided in Example 1.
Density=0.80 g/cc
Shore D Hardness=56

### Example 3

52.00 kilograms of Airthane PHP-75D and 780 grams of Desmodur N 3300A were charged into a first tank and held at 140° F. and 80 PSI of nitrogen pressure and mixed with low agitation. A curative mixture was prepared by melting 32.19 kilograms of Lonzacure MCDEA then 11.51 kilograms of Versalink P650 and 690 grams of Niax L1800 were added with stirring. This mixture was brought to a temperature of 180° F. then 306 grams of Lanco PP1362D were added and stirred until uniformly dispersed. Next 720 grams of water were added with rapid stirring. This curative mixture was then charged into a second tank and held at 180° F. and 40 psi of nitrogen pressure. The fluids of the first and second tanks were fed into a mixer, by constant delivery pumps, at a weight ratio of 214 grams from the first tank to 100 grams from the second tank. The fluids were mixed under high agitation and dispensed into an open circular mold having a diameter of 25 inches and a thickness of 0.125 inches which had been preheated to 125° F. The open mold was placed in an oven at 230° F. for 20 minutes. After this time, the product was removed from the mold. Curing was continued for 18 hours at 230° F. The product was then allowed to cool to ambient temperature.

Circular pads having a 22.5″ diameter were cut from the sheet using a press with cutting die. The pad was then cut to a thickness of 0.050 inches and the upper and lower surfaces of the pad were made parallel using a milling machine.

The following values were measured in accordance with the procedures described in Example 1.
Density=0.86 g/cc
Shore D Hardness=57
Tensile Strength=3160
Elongation=180%

### Example 4

The polishing pad of Example 3 was fabricated into a three-layer polishing pad assembly. The polishing pad was connected to a second (i.e., middle) layer. The second layer consisted of a sheet of double-coated polyester film tape and release liner, commercially obtained from 3M under product number 9609. The adhesive side was applied to the polishing pad such that it essentially covered the lower surface of the polishing pad. The release liner on the other side of the second layer was then removed to expose the adhesive, and a third layer was applied to the exposed adhesive layer. The third layer consisted of a polyurethane foam disk having a diameter of 22.5″, a thickness of 1/16″ and a density of 0.48 g/cm³. Another double-coated film tape with release liner was commercially obtained from 3M under product number 442. The adhesive side was applied to the exposed surface of the polyurethane foam. The remaining release liner on the other side can be removed to permit attachment to a commercial planarizing apparatus.

### Example 5

The polishing pad of Example 2 was fabricated into a three-layer polishing pad assembly. The polishing pad was connected to a second (i.e., middle) layer. The second layer consisted of a sheet of double-coated polyester film tape and release liner, commercially obtained from 3M under product number 9609. The adhesive side was applied to the polishing pad such that it essentially covered the lower surface of the polishing pad. The release liner on the other side of the second layer was then removed to expose the adhesive, and a top layer was applied to the exposed adhesive layer. The top layer consisted of a polyurethane foam disk having a diameter of 22.5″, a thickness of 1/16″ and a density of 0.32 g/cm³. Another double-coated film tape with release liner was commercially obtained from 3M under product number 442. The adhesive side was applied to the exposed surface of the polyurethane foam. The remaining release liner on the other side can be removed to permit attachment to a commercial planarizing apparatus.

### Example 6

50.00 kilograms of Airthane PHP-75D were charged into the first tank of a Baulé three-component low pressure-dispensing machine and held at 140° F. with 15 psi of nitrogen pressure. This tank was mixed with low agitation. A mixture was prepared by melting 44.3 kilograms of Lonzacure MCDEA at a temperature of 210° F., and then adding with stirring 798 grams of Niax L1800. Next, 318 grams of Lanco PP1362D were added and stirred until substantially uniformly dispersed. This curative mixture was then charged into the second tank of the low pressure-dispensing machine and held at 210° F. with 50 psi of nitrogen pressure and mixed with low agitation. Then, a mixture of 250 grams of deionized water and 250 grams of Dow Corning Surfactant 193 were charged into the third tank at ambient temperature and pressure. The fluids of the first, second and third tanks were fed into a mixer, by constant delivery pumps, at a weight ratio of 251 grams from the first tank to 100 grams from the second tank to 3.50 grams from the third tank. The fluids were mixed under high agitation and dispensed into an open circular mold having a diameter of 31 inches and a thickness of 0.090 inches, which had been preheated to 161° F. The open mold was placed in an oven at 160° F. for 15 minutes. After this time, the product was removed from the mold. Curing was continued for 18 hours at 230° F. The product was then allowed to cool to ambient temperature.

A circular pad having a 22.5″ diameter was cut from the molded part. The pad was then cut to a thickness of 0.065 inches and the upper and lower surfaces of the pad were made parallel using a milling machine. Concentric circular grooves 0.010″ wide×0.020″ deep with a pitch of 0.060″ were machined into the work surface.

The following values were measured in accordance with the procedures described in Example 1.
Density=0.83 g/cc
Shore D Hardness=63

1. A pad adapted to polish a microelectronic substrate, said pad comprising polyurethane urea, wherein said polyurethane urea comprises at least partially gas-filled cells, and wherein at least a portion of said at least partially gas-filled cells is formed by an in-situ reaction.

2. A pad adapted to polish a microelectronic substrate, said pad comprising polyurethane urea, wherein said polyurethane urea comprises at least partially gas-filled cells, said polyurethane urea formed by reaction of polyurethane prepolymer with amine-containing material and blowing agent.

3. A pad adapted to polish a microelectronic substrate, said pad comprising polyurethane urea, wherein said polyurethane urea comprises at least partially gas-filled cells, said polyurethane urea formed by reaction of polyisocyanate with hydroxyl-containing material, amine-containing material and blowing agent.

4. A pad adapted to polish a microelectronic substrate, said pad comprising polyurethane urea, wherein said polyurethane urea comprises at least partially gas-filled cells, said polyurethane urea formed by reaction of polyisocyanate and polyurethane prepolymer, amine-containing material, blowing agent, and optionally hydroxyl-containing material.

5. The pad of claim 1, wherein said polyurethane urea is formed by reaction of hydroxyl-containing material, amine-containing material, blowing agent and at least one material selected from the group consisting of polyisocyanate, polyurethane prepolymer and mixtures thereof.

6. The pad of claim 1, wherein gas in at least a portion of said at least partially gas-filled cells is exposed when at least a portion of a work surface of said pad is at least partially worn away when said work surface is in contact with a substrate to be polished.

7. The pad of claim 3 wherein said polyisocyanate has at least two isocyanate functional groups.

8. The pad of claim 3 wherein said polyisocyanate is selected from the group consisting of polymeric and C₂-C₂₀ linear, branched, cyclic and aromatic polyisocyanates.

9. The pad of claim 2 wherein said hydroxyl-containing material is selected from the group consisting of polyether polyols, polyester polyols, polycaprolactone polyols, polycarbonate polyols, and mixtures thereof.

10. The pad of claim 2, wherein said amine-containing material is selected from the group consisting of aliphatic polyamines, cycloaliphatic polyamines, aromatic polyamines and mixtures thereof.

11. The pad of claim 2, wherein said amine-containing material comprises a polyamine and at least one material selected from the group consisting of polythiol and polyol.

12. The pad of claim 2, wherein said amine-containing material further comprises sulfur.

13. The pad of claim 2, further comprising at least one material selected from urethane catalyst, blowing catalyst, surfactant, and nucleating agent.

14. The pad of claim 1 wherein said pad has a work surface and said surface comprises at least one feature selected from the group consisting of channels, grooves and perforations.

15. The pad of claim 1 wherein said polyurethane urea comprises abrasive particulate material.

16. The pad of claim 15 wherein said abrasive particulate material is distributed substantially uniformly throughout said polyurethane urea.

17. The pad of claim 15 wherein said abrasive particulate material is present in an amount of from 5% by weight to less than 70% by weight based on the total weight of the pad.

18. The pad of claim 15 wherein said abrasive particulate material has an average particle size of from 0.001 micron to less than 50 microns.

19. The pad of claim 15 wherein said abrasive particulate material is silica.

20. The pad of claim 1 further comprising a sub-pad.

21. The pad of claim 20 wherein said sub-pad comprises non-woven or woven fiber mat.

22. The pad of claim 20 wherein said sub-pad is chosen from polyolefin, polyester, polyamide, or acrylic fibers, which have been impregnated with a resin, and combinations thereof.

23. The pad of claim 20 wherein said sub-pad is chosen from polyurethane or polyurethane urea impregnated felt, and foam sheet made of natural rubber, synthetic rubber, thermoplastic elastomer, or combinations thereof.

24. The pad of claim 20 wherein said polishing pad is at least partially connected to said sub-pad.

25. The pad of claim 1 further comprising a second layer.

26. The pad of claim 25 wherein said second layer is at least partially connected to said polishing pad.

27. The pad of claim 26 wherein said second layer is at least partially connected to said sub-pad.

28. The pad of claim 25 wherein said second layer is chosen from polyolefins, cellulose-based polymers, acrylics, polyesters and co-polyesters, polycarbonates, polyamides, plastics, and mixtures thereof.

29. The pad of claim 25 wherein said second layer is chosen from substantially non-compressible polymers, metallic films and foils, and mixtures thereof.

30. A process for preparing a pad adapted to polish microelectronic substrates, comprising combining polyisocyanate with hydroxyl-containing material, amine-containing material and blowing agent to produce polyurethane urea wherein at least a portion of said urea contains at least partially gas-filled cells.

31. A process for preparing a pad adapted to polish microelectronic substrates, comprising combining at least one material selected from the group consisting of polyisocyanate, polyurethane prepolymer and mixtures thereof, with hydroxyl-containing material, amine-containing material and blowing agent to produce polyurethane urea wherein at least a portion of said urea contains at least partially gas-filled cells.

32. A process for preparing a pad adapted to polish microelectronic substrates, comprising combining polyisocyanate with hydroxyl-containing material to form polyurethane prepolymer; and combining said polyurethane prepolymer with amine-containing material and blowing agent to form polyurethane urea wherein at least a portion of said urea contains at least partially gas-filled cells.

33. The process of claim 31 wherein ingredients are combined at a pressure of less than 20 bar.

34. The process of claim 31 wherein ingredients are combined at a pressure of at least 20 bar.

35. The process of claim 31 wherein said at least partially gas-filled cells comprise carbon dioxide.

36. The process of claim 31 wherein said at least partially gas-filled cells have an average size of from at least 1 micron to less than 100 microns.

37. The process of claim 31 wherein said substantially gas-filled cells are substantially uniformly distributed throughout said polyurethane urea.

38. The process of claim 31 wherein said blowing agent comprises water.

39. The process of claim 32 wherein said at least partially gas-filled cells comprise carbon dioxide.

40. The process of claim 32 wherein said at least partially gas-filled cells have an average size of from at least 1 micron to less than 100 microns.

41. The process of claim 32 wherein said at least partially gas-filled cells are substantially uniformly distributed throughout said polyurethane urea.

42. The process of claim 32 wherein said blowing agent is water.

43. The process of claim 32 further comprising adding an auxiliary blowing agent.

44. The process of claim 32 further comprising combining said polyurethane prepolymer with an auxiliary blowing agent.

45. The process of claim 44 wherein said auxiliary blowing agent is chosen from acetone, ethyl acetate, halogen-substituted alkanes, and mixtures thereof.

46. The process of claim 45 wherein said auxiliary blowing agent is chosen from acetone, ethyl acetate, halogen-substituted alkanes, and mixtures thereof.

47. The process of claim 31 further comprising at least partially connecting a second layer to said pad.

48. The process of claim 47 further comprising at least partially connecting a sub-pad to said second layer.

49. A pad assembly comprising:
a. a polishing pad comprising polyurethane urea wherein at least a portion of said polyurethane urea comprises at least partially gas-filled cells wherein at least a portion of said cells are formed by an in-situ reaction, said polishing pad having a work surface and a back surface;
b. a backing sheet having an upper surface and a lower surface; and
c. an adhesive means interposed between and at least partially connecting said back surface of said polishing pad and an upper surface of said backing sheet.

50. The pad assembly of claim 49 wherein said polyurethane urea is formed by combining hydroxyl-containing material, amine-containing material, blowing agent and at least one material selected from the group consisting of polyisocyanate, polyurethane prepolymer and mixtures thereof.

51. A pad assembly comprising:
a. a polishing pad comprising polyurethane urea wherein at least a portion of said polyurethane urea comprises at least partially gas-filled cells wherein at least a portion of said cells are formed by an in-situ reaction, said polishing pad having a work surface and a back surface; and
b. a second layer having an upper surface and a lower surface,
wherein said back surface of said polishing pad is at least partially connected to said upper surface of said second layer.

52. The pad assembly of claim 51 wherein said polyurethane urea is formed by combining hydroxyl-containing material, amine-containing material, blowing agent and at least one material selected from the group consisting of polyisocyanate, polyurethane prepolymer and mixtures thereof.

53. A pad assembly comprising:
a. a polishing pad comprising polyurethane urea wherein at least a portion of said polyurethane urea comprises at least partially gas-filled cells wherein at least a portion of said cells are formed by an in-situ reaction, said polishing pad having a work surface and a back surface;
b. a second layer having an upper surface and a lower surface; and
c. a sub-pad having an upper surface and a lower surface,
wherein said back surface of said polishing pad is at least partially connected to said upper surface of said second layer, and said lower surface of said second layer is at least partially connected to said upper surface of said sub-pad.

54. The pad assembly of claim 53 wherein said polyurethane urea is formed by combining hydroxyl-containing material, amine-containing material, blowing agent and at least one material selected from the group consisting of polyisocyanate, polyurethane prepolymer and mixtures thereof.
